(19) United States
(12) Patent Application Publication
(10) Pub. No.: US 2025/0012428 A1
(43) Pub. Date: Jan. 9, 2025

(54) Lamp Strip and Light-emitting Device

(71) Applicant: SHANGYOU JIAYI LIGHTING PRODUCT CO., LTD., Ganzhou (CN)

(72) Inventor: Yaowen HE, Ganzhou City (CN)

(21) Appl. No.: 18/404,416

(22) Filed: Jan. 4, 2024

(30) Foreign Application Priority Data
Jul. 3, 2023 (CN) 2023217215293

(51) Int. Cl. F21V 19/00; F21S 4/24; F21V 15/01; F21Y 103/10; F21Y 115/10

(52) U.S. Cl. CPC F21V 19/0025; F21S 4/24; F21V 15/012; F21Y 2103/10; F21Y 2115/10

(57) ABSTRACT

The present disclosure provides a lamp strip and a light-emitting device, relating to the technical field of lamp strips. The lamp strip includes a lamp strip jacket, a plurality of illuminant components, and wires for connecting the plurality of illuminant components; the wires and the illuminant components are arranged in the lamp strip jacket, and the lamp strip jacket is configured to form a protective structure for the wires and the plurality of illuminant component; the illuminant components each include a fixing plate and a patch lamp bead; the fixing plate is configured to be connected to the wire, and bear the patch lamp bead; and the wire is configured to transmit an electrical signal to the patch lamp bead through the fixing plate, so as to turn on the patch lamp bead.

### CROSS-REFERENCE TO RELATED APPLICATIONS

The present application claims priority to Chinese patent application No. 2023217215293, entitled “Lamp Strip and Light-emitting Device”, filed to the China Patent Office on Jul. 3, 2023, the entire content of which is incorporated herein by reference.

### TECHNICAL FIELD

The present disclosure relates to the technical field of lamp strips, in particular to a lamp strip and a light-emitting device.

### BACKGROUND ART

Existing lamp strips are all printed circuit board lamp strips. Such lamp strips form a tubular lamp strip by sleeving an insulating layer outside. Alternatively, a flexible circuit board is used, and an insulating layer is covered on a front surface of the flexible circuit board, so as to form a corresponding lamp strip.

However, due to restriction of the circuit board to the lamp strips in the prior art, a single circuit board cannot be made very long, and multiple segments need to be connected, so as to perform a subsequent operation of pulling the tube, thus, the existing lamp strips are restricted in length, and cannot satisfy scenes that need a long lamp strip.

Besides, when LED patch lamp beads are used in the existing lamp strips, the patch lamp beads are usually directly soldered on a wire, and then wrapped by glue outside. During soldering, a temperature is relatively high, soldering spots of the LED lamp beads are very easy to be heated, causing stripping from a support, and chips in the lamp beads will also be in poor contact due to thermal expansion and contraction, finally causing occurrence of phenomenon of false soldering (non-wetting), pseudo soldering (poor soldering), or damaged lamp to the product.

Therefore, the existing lamp strips are not only restricted in length, but also have poor product stability.

### SUMMARY

In view of this, the present disclosure aims at providing a lamp strip and a light-emitting device, which can satisfy any scenes that need a long lamp strip, moreover, the lamp strip also has stronger stability.

In a first aspect, an embodiment of the present disclosure provides a lamp strip. The lamp strip includes a lamp strip jacket, a plurality of illuminant components, and wires for connecting the plurality of illuminant components; the wires and the plurality of illuminant components are arranged in the lamp strip jacket, and the lamp strip jacket is configured to form a protective structure for the wires and the plurality of illuminant component, wherein the illuminant components each include a fixing plate and a patch lamp bead, wherein the fixing plate is configured to be connected to the wire, and bear the patch lamp bead; and the wire is configured to transmit an electrical signal to the patch lamp bead through the fixing plate, so as to turn on the patch lamp bead.

In combination with the first aspect, an embodiment of the present disclosure provides a first possible embodiment of the first aspect, wherein the patch lamp bead includes a plurality of pins; and a plurality of the wires are provided corresponding to the pins; a first plane of the fixing plate is provided with a plurality of first connection terminals, and a second plane of the fixing plate is provided with a plurality of second connection terminals; and the patch lamp bead is fixedly connected to the first connection terminals through the pins, and the second connection terminals are configured to be connected with the wire.

In combination with the first aspect, an embodiment of the present disclosure provides a second possible embodiment of the first aspect, wherein the patch lamp bead is connected to the fixing plate by means of reflow soldering.

In combination with the first aspect, an embodiment of the present disclosure provides a third possible embodiment of the first aspect, wherein the lamp strip jacket includes a wire sheath and a lamp bead cover body, and the lamp bead cover body and the wire sheath are connected; and the lamp bead cover body is provided outside the illuminant component; and the wire sheath is wrapped outside the wire.

In combination with the first aspect, an embodiment of the present disclosure provides a fourth possible embodiment of the first aspect, wherein the wire sheath is of a colloidal structure; the lamp bead cover body is a sealing layer, and sealing layers corresponding to the illuminant components are connected by the colloidal structure corresponding to the wire sheath.

In combination with the first aspect, an embodiment of the present disclosure provides a fifth possible embodiment of the first aspect, wherein the lamp strip further includes a plurality of fasteners, and the fasteners are each configured to be fixed outside the lamp strip jacket; the plurality of fasteners are provided at intervals along a length direction of the lamp strip jacket; and the fasteners are configured to fix the lamp strip to an external structure.

In combination with the first aspect, an embodiment of the present disclosure provides a sixth possible embodiment of the first aspect, wherein the fasteners include colloidal structures, and are configured to stick and fix the lamp strip.

In combination with the first aspect, an embodiment of the present disclosure provides a seventh possible embodiment of the first aspect, wherein the plurality of second connection terminals are distributed at two opposite sides of the fixing plate; and the plurality of wires corresponding to the second connection terminals at each side are arranged side by side along a width direction of the fixing plate, so that the lamp strip is of a flat strip-like structure.

In combination with the first aspect, an embodiment of the present disclosure provides an eighth possible embodiment of the first aspect, wherein the lamp strip further includes a connection line material; and the connection line material has a same extending direction as the lamp strip, and covers the lamp strip.

In a second aspect, an embodiment of the present disclosure further provides a light-emitting device, wherein the light-emitting device is provided with the above lamp strip.

The embodiments of the present disclosure bring the following beneficial effects: the present disclosure provides a lamp strip and a light-emitting device, wherein the lamp strip includes the lamp strip jacket, the plurality of illuminant components, and the wires for connecting the plurality of illuminant components; the wires and the plurality of illuminant components are arranged in the lamp strip jacket, and the lamp strip jacket is configured to form the protective structure for the wires and the plurality of illuminant component, and wherein the illuminant components each include a fixing plate and a patch lamp bead; the fixing plate is configured to be connected to the wire, and bear the patch lamp bead; and the wire is configured to transmit an electrical signal to the patch lamp bead through the fixing plate, so as to turn on the patch lamp bead. In the present disclosure, by connecting the wire and the patch lamp bead through the fixing plate, the patch lamp bead and the fixing plate can be stably connected. Moreover, the wire can be stably connected to the fixing plate, so that the lamp strip has stronger tension, and the patch lamp bead can be protected against damage by temperature. Besides, the wire is not restricted in length, and the length of the wire can be arbitrarily set as needed, so that the length of the lamp strip can satisfy any application scenes that need a long lamp strip.

Other features and advantages of the present disclosure will be set forth in the following description, and part of them will become apparent from the description, or may be learned by implementing the present disclosure. The objectives and other advantages of the present disclosure are achieved and obtained through the structures specifically indicated in the description and the drawings.

In order to make the above objectives, features, and advantages of the present disclosure more obvious and understandable, preferred embodiments are particularly illustrated in the following to give detailed description in conjunction with the drawings.

### BRIEF DESCRIPTION OF DRAWINGS

In order to more clearly illustrate the technical solutions in the embodiments of the present disclosure or the prior art, the drawings that need to be used in the description of the embodiments or the prior art will be briefly introduced below. Obviously, the drawings in the following description show some embodiments of the present disclosure. Those ordinarily skilled in the art still could obtain other drawings according to these drawings without using any inventive efforts.

FIG. 1 is a structural schematic diagram of a lamp strip provided in an embodiment of the present disclosure;

FIG. 2 is a structural schematic diagram of another lamp strip provided in an embodiment of the present disclosure;

FIG. 3 is a structural schematic diagram of another lamp strip provided in an embodiment of the present disclosure; and

FIG. 4 is a structural schematic diagram of another lamp strip provided in an embodiment of the present disclosure.

In the drawings: 10-lamp strip jacket; 20-illuminant component; 20a-illuminant component a; 20b-illuminant component b; 20c-illuminant component c; 201-patch lamp bead; 201a-patch lamp bead a; 201b-patch lamp bead b; 201c-patch lamp bead c; 202-fixing plate; 202a-fixing plate a; 202b-fixing plate b; 202c-fixing plate c; 30-wire; 30a-wire a; 30b-wire b; 2021-first connection terminal; 2022-second connection terminal; 101-lamp bead cover body; 102-wire sheath.

### DETAILED DESCRIPTION OF EMBODIMENTS

In order to make objectives, technical solutions, and advantages of the embodiments of the present disclosure clearer, the technical solutions in the present disclosure will be described clearly and completely below with reference to the drawings. Obviously, some but not all embodiments of the present disclosure are described. Based on the embodiments in the present disclosure, all of other embodiments obtained by those ordinarily skilled in the art without using any inventive efforts shall fall within the scope of protection of the present disclosure.

Existing lamp strips are all printed circuit board lamp strips. Such lamp strips form a tubular lamp strip by sleeving an insulating layer outside. Alternatively, a flexible circuit board is used, and an insulating layer is covered on a front surface of the flexible circuit board, so as to form a corresponding lamp strip.

However, due to restriction of the circuit board to the lamp strips in the prior art, a single circuit board cannot be made very long, and multiple segments need to be connected, so as to perform a subsequent operation of pulling the tube, thus, the existing lamp strips are restricted in length, and cannot satisfy scenes that need a long lamp strip.

Besides, when LED patch lamp beads are used in the existing lamp strips, the patch lamp beads are usually directly soldered on a wire, and then wrapped by glue outside. During soldering, a temperature is relatively high, soldering spots of the LED lamp beads are very easy to be heated, causing stripping from a support, and chips inside the lamp beads will also have poor contact due to thermal expansion and contraction, finally causing occurrence of phenomenon of false soldering, pseudo soldering, or damaged lamp to the product.

Therefore, the existing lamp strips are not only restricted in length, but also have poor product stability.

In view of this, embodiments of the present disclosure provide a lamp strip and a light-emitting device, which can satisfy any scenes that need a long lamp strip, moreover, the lamp strip also has stronger stability.

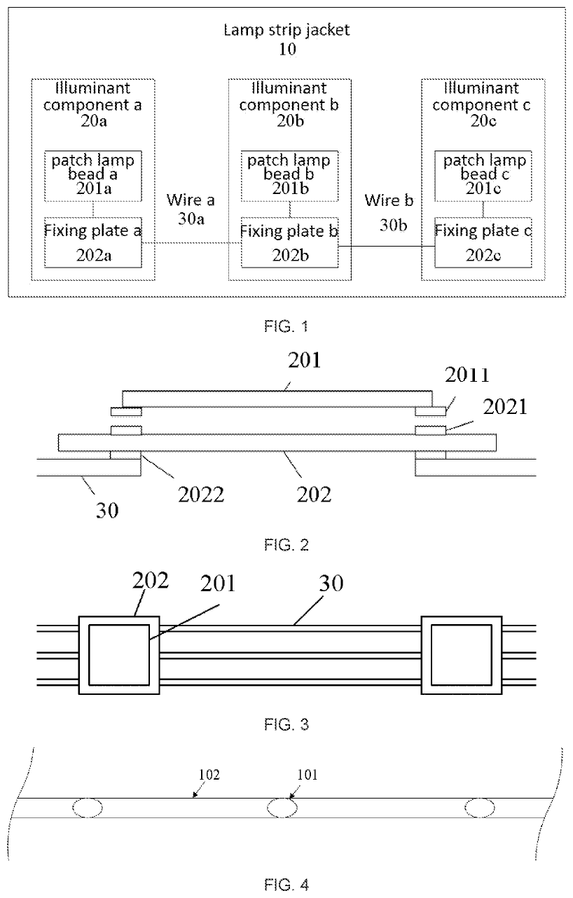

To facilitate understanding of the present embodiment, first, a lamp strip disclosed in an embodiment of the present disclosure is described in detail. FIG. 1 shows a structural schematic diagram of a lamp strip provided in an embodiment of the present disclosure. As shown in FIG. 1, the lamp strip includes a lamp strip jacket 10, a plurality of illuminant components, and wires for connecting the plurality of illuminant components. In the above, the wires and the plurality of illuminant components are arranged in the lamp strip jacket 10, and the lamp strip jacket 10 is configured to form a protective structure for the wires and the plurality of illuminant components.

Specifically, the lamp strip in the present disclosure is connected with the illuminant components through the wires. Length of the wires is not limited, and can be set arbitrarily as needed. In the above, each illuminant component in the present disclosure includes a fixing plate and a patch lamp bead, wherein the fixing plate is used to be connected to the wire, and bear the patch lamp bead.

In the above, the plurality of illuminant components in FIG. 1 are represented by an illuminant component a, an illuminant component b, and an illuminant component c, respectively. Respective corresponding fixing plates are represented by a fixing plate a-202a, a fixing plate b-202b, and a fixing plate c-202c. The patch lamp beads are represented by a patch lamp bead a-201a, an patch lamp bead b-201b, and an patch lamp bead c-201c. Each two illuminant components are connected by a segment of wire, and each segment of wire is represented by a wire a-30a, a wire b-30b and so on, respectively. FIG. 1 shows three illuminant components, and two corresponding segments of wire.

In specific implementation, the wire is configured to transmit an electrical signal to the patch lamp bead through the fixing plate, so as to turn on the patch lamp bead. In the above, the patch lamp bead can be fixed on the fixing plate, and then connected to the wire through the fixing plate, so as to form the lamp strip. In order to realize the transmission of the electrical signal, a pin of each patch lamp bead needs to be capable of being in communication with the wire. In the embodiments of the present disclosure, the electrical signal is transmitted by fixing the patch lamp bead to the fixing plate, and then soldering the wire with the fixing plate. In the above, soldering heat is located on the fixing plate and will not damage the patch lamp bead, thus the phenomenon of false soldering, pseudo soldering or damaged lamp of the lamp bead can be avoided. After the wires and the illuminant components are connected, the lamp strip jacket 10 is further needed to shield the wires and the illuminant components. The lamp strip jacket 10 can wrap the wires and the plurality of illuminant components, to form a strip-like product, thereby obtaining the lamp strip in the embodiment of the present disclosure.

For the lamp strip provided in the embodiments of the present disclosure, by connecting the wire and the patch lamp bead by the fixing plate, the patch lamp bead and the fixing plate can be stably connected, and the wire can be stably connected to the fixing plate, thereby preventing occurrence of phenomenon of false soldering, pseudo soldering or damaged lamp to a product. In addition, the wire is not restricted in length, and the length of the wire can be set arbitrarily as needed, so that the length of the lamp strip can satisfy any application scenes that need a long lamp strip.

Further, on the basis of the above embodiments of the present disclosure, an embodiment of the present disclosure further provides another lamp strip. The above patch lamp bead 201 includes a plurality of pins 2011; a plurality of wires 30 are provided corresponding to the pins 2011. In addition, the fixing plate 202 is of a plate-like structure, and includes two planes, wherein a first plane of the fixing plate 202 is provided with a plurality of first connection terminals, and a second plane of the fixing plate 202 is provided with a plurality of second connection terminals; and the patch lamp bead 201 is fixedly connected to the first connection terminals through the pins 2011, and the second connection terminals are used to be connected with the wire 30. FIG. 2 shows a structural schematic diagram of another lamp strip provided in an embodiment of the present disclosure, wherein FIG. 2 is a schematic diagram of relative structure of the wire, the fixing plate, and the patch lamp bead.

In specific implementation, the number of pins 2011, the number of first connection terminals 2021, and the number of second connection terminals 2022 are the same, and the first connection terminals are connected to corresponding second connection terminals, to form a connection terminal group together. After the wires 30 are connected to corresponding second connection terminals 2022, an electrical signal can be transmitted to the patch lamp bead 201 through the connection terminal group corresponding to the second connection terminals 2022.

Specifically, the pins 2011 of the patch lamp bead 201 may include a power supply pin, and corresponding wire 30 also has a power supply line. The power supply line is just connected to the second connection terminals 2022 corresponding to the power supply pin. The patch lamp bead 201 in the present disclosure can be a monochromatic lamp bead, such as a white light lamp bead, or an RGB LED lamp bead. After the power supply line is connected to a power supply, the patch lamp bead 201 connected can be turned on. Further, the pins 2011 of the patch lamp bead 201 further may include a signal pin, which can be used to receive a lamp bead lightening signal, and this signal can control a lightening mode or a lightening color of the lamp bead. Correspondingly, the wire 30 also includes a signal line.

In the above, the patch lamp bead 201 is provided with a control circuit, and the lightening is realized through conduction of the control circuit. Correspondingly, positions of the plurality of pins 2011 of the patch lamp bead 201 can be determined based on a position of a connection contact of the control circuit. Specifically, the control circuit includes an IC chip and a lamp bead. In the present disclosure, the lamp strip structure is mainly designed, and how to connect the IC chip and the lamp bead is not redundantly described herein. According to different use requirements, the position of the connection contact of the control circuit is also different, i.e., the position of the power supply pin and the position of the signal pin of the patch lamp bead 201 can be adaptively set according to the use requirements.

In specific implementation, the connection contact of the control circuit at least includes a chip positive pole and a chip negative pole of the IC chip; and these connection contacts may be corresponding to the power supply pins of the patch lamp bead 201 in the present disclosure, and there are a plurality of power supply pins. Further, a plurality of lamp beads of some lamp strings are connected in parallel, and corresponding connection contacts further can include a signal input contact, wherein the signal input contact may be corresponding to the signal pin of the patch lamp bead 201. Besides, a plurality of lamp beads of some lamp strings may be connected in series, and the connection contacts may further include a signal output contact. In this structure, the patch lamp bead 201 has two signal pins.

In specific implementation, in an embodiment of the present disclosure, a plurality of illuminant components are connected by the wires 30 to form a lamp strip. The lamp strip extends in a length direction of the wires 30. The plurality of illuminant components are also sequentially arranged based on the length direction of the wires 30. In order to transmit the electrical signal to the plurality of illuminant components sequentially through the wires 30, the signal pins of the signal input contacts and the signal pins of the signal output contacts can be arranged opposite to each other along the length direction of the wires 30, for example, when the wires 30 are arranged at both left and right sides of the fixing plates 202, the signal pins of the signal input contacts and the signal pins of the signal output contacts are arranged at left and right sides opposite to each other. For two illuminant components, the signal pin of the signal output contact corresponding to one illuminant component is connected to the signal pin of the signal input contact of the other illuminant component. In this case, the lamp beads 201 of the lamp strip are connected in series. The power supply pins are provided in the same way as needed. In this case, the second connection terminals 2022 are adaptively provided at corresponding positions.

In the above, each fixing plate 202 in the present disclosure may be a PCB board. The first plane may be a front surface of the fixing plate 202, and the patch lamp bead 201 can contact and be connected to the plurality of first connection terminals 2021 on the first plane through the pins 2011 thereof, so as to be fixed on the fixing plate 202. In specific implementation, the patch lamp bead 201 is connected to the fixing plate 202 by means of reflow soldering. The patch lamp bead 201 can be first soldered on the PCB board by means of reflow soldering, soldering spots (i.e., the second connection terminals 2022 in the above) are left on the second plane of the PCB board, and then the wires 30 are soldered to the second connection terminals 2022 of the PCB board (the fixing plate 202), thereby forming the lamp strip. The first plane is the front surface of the fixing plate 202, and the second plane may be a back surface of the fixing plate 202.

Further, as the fixing plate 202 is of a plate-like structure, and the second connection terminals 2022 configured to connect the wires 30 are disposed on the same plane, in this case, a plurality of wires 30 corresponding to the second connection terminals 2022 at each side can be provided side by side along a width direction of the fixing plate 202, so that the lamp strip is of a flat strip-like structure. As the patch lamp bead 201 is fixed on the fixing plate 202, the second connection terminals 2022 of the fixing plate 202 only need to be connected to the corresponding first connection terminals 2021, so as to form a connection terminal group. In the above, in the present disclosure, the pins corresponding to the chip positive pole and the pins corresponding to the chip negative pole can be distributed on the left and right, the pins corresponding to signal input contact can be arranged between the pins of the chip positive pole and the pins of the chip negative pole. In this case, there are three second connection terminals, which are arranged from left to right. After the second connection terminals are connected to the wire, the wire is of a triplex structure. In the above, based on the extending direction of the wire connected, the lamp strip in the present disclosure is of a strip-shaped structure. Further, when the lamp beads are connected in series, that is, when the patch lamp bead further includes a signal output contact, the signal input contact and the signal output contact can be arranged vertically. In this case, there are four second connection terminals, which are distributed vertically and horizontally, and correspondingly, the wire is still of the triplex structure.

Referring to FIG. 3, FIG. 3 shows a structural schematic diagram of another lamp strip. FIG. 3 is a schematic diagram of a connection structure of the fixing plates, the patch lamp beads, and the wires. In FIG. 3, three parallel wires connect a plurality of fixing plates in turn. When various patch lamp beads are connected in series, each wire between the fixing plates can be divided into two left and right segments, wherein one segment is connected to the second connection terminals of the signal input contact corresponding to the fixing plate, and the other segment is connected to the second connection terminals of the signal output contact corresponding to the fixing plate. In this case, the wire of the lamp strip is still of the triplex structure.

In addition, plate surfaces of the fixing plate 202 are flat and are not limited too much, therefore, wiring can be facilitated. The patch lamp beads 201 with the pins 2011 of different numbers can be turned on by means of the fixing plate 202, the connection terminal group, and the wire 30. For example, after the patch lamp beads 201 connected in parallel, the patch lamp beads 201 connected in series, or the patch lamp beads 201 having more complex lines can be connected on the fixing plate 202, communication is achieved by connecting the second connection terminals 2022 which are flexibly positioned with the wire 30, so that the lamp strip in the present disclosure always satisfies the design of a flat strip-like structure. Moreover, types of the patch lamp beads 201 provided do not need to be limited, thereby facilitating the production.

Referring to FIG. 4, FIG. 4 is a structural schematic diagram of another lamp strip provided in an embodiment of the present disclosure. This structural schematic diagram is a diagram of appearance of the lamp strip. It can be seen from FIG. 4 that the lamp strip is of a flat structure. Moreover, as various illuminant components are connected by the wires 30, the length of the wires 30 is not limited, and a length of the lamp strip in the present disclosure is not limited, either, thus many scenes that need a long lamp strip can be satisfied.

Further, the lamp strip jacket 10 in the present disclosure includes a wire sheath 102 and a lamp bead cover body 101, wherein the lamp bead cover body 101 is connected to the wire sheath 102; the lamp bead cover body 101 is provided outside the illuminant component; and the wire sheath 102 is wrapped outside the wire 30. In specific implementation, the wire sheath 102 is of a colloidal structure, such as a PVC material; the lamp bead cover body 101 is a sealing layer, and a sealing layer corresponding to the illuminant component is connected by the colloidal structure corresponding to the wire sheath 102. In the above, the lamp bead cover body 101 outside the illuminant component may be made of a UV adhesive material. The wire sheath 102 can be firstly sealed outside the wire 30 (i.e., an insulating layer is sleeved over the wire 30), then the UV adhesive is placed on the illuminant component, and the sealing layer can be formed after the UV adhesive is solidified. Moreover, the UV adhesive is a semi-transparent colloid, which can ensure sealing property and waterproof property of the lamp strip, without affecting light emission of the lamp bead.

Besides, the lamp strip formed by the wire sheath 102 of the colloidal structure and the lamp bead cover bodies 101 forming the sealing layer has relatively good flexibility. Further, the patch lamp beads 201 in the present disclosure are reflow-soldered on the fixing plates 202. Moreover, through the structure of soldering the second connection terminals 2022 and the wires 30, the soldering spots of the patch lamp beads 201 are prevented from being heated during the soldering, thus occurrence of phenomenon of false soldering, pseudo soldering, or damaged lamp to the product can be avoided.

Specifically, when the patch lamp beads 201 are connected to the fixing plates 202 through the reflow soldering, the soldering temperature is relatively low, which will not cause the situation that the soldering spots of the patch lamp beads 201 are heated and stripped from the support, and the chips in the patch lamp beads 201 will not be in poor contact due to thermal expansion and contraction, finally causing occurrence of phenomenon of false soldering, pseudo soldering, or damaged lamp to the product. When soldering the fixing plates 202 and the wires 30, heat is distributed on the fixing plates 202, and the soldering spots are not in direct contact with the patch lamp beads 201, further preventing the soldering spots of the patch lamp beads 201 from being heated, thus the patch lamp beads 201 will not be damaged. Further, after the wires 30 are soldered to the fixing plates 202, the soldering spot structure has more contact surfaces than the patch lamp beads 201, then the soldering structure is more stable.

Further, the lamp strip in the embodiments of the present disclosure also includes a plurality of fasteners. Each fastener is configured to be fixed outside the lamp strip jacket 10. The plurality of fasteners are provided at intervals along a length direction of the lamp strip jacket 10. The fasteners are configured to fix the lamp strip to an external structure. For example, when the lamp strip is used for illumination or decoration, the lamp strip can be fixed at a desired position by the fasteners. In specific implementation, the fasteners include colloidal structures, such as double-sided adhesive, nano adhesive, jelly glue, foam adhesive, and 3M adhesive, and are used to stick and fix the lamp strip. In the above, as the lamp strip is of the flat strip-like structure, the lamp strip can be directly stuck at a place where the lamp strip needs to be mounted by the fasteners that are colloidal structures. Further, the fasteners may also be snap-fit structures or clip structures. In the above, a specific form of the fasteners only needs to be capable of fixing the lamp strip at a desired position, and other possible forms are not elaborated herein one by one.

Further, the lamp strip in the embodiments of the present disclosure further includes a connection line material, wherein the connection line material has the same extending direction as the lamp strip, and covers the lamp strip. Referring to FIG. 3, the connection line material can be arranged parallel to the wires, and the connection line material is not shown in the drawing. The connection line material is configured to enhance the strength of the lamp strip. In specific implementation, the connection line material may be a thin steel wire with tensile resistance. In the above, the connection line material can be provided in the lamp strip jacket 10, so that the appearance of the lamp strip in the present disclosure only shows the wire sheath 102 of the colloidal structure and the lamp bead cover body 101 which is the sealing layer. In this case, the appearance of the present disclosure is simple, the whole lamp strip is smooth without concave or convex parts, and the lamp strip is more beautiful after being stuck to a mounting position by the fasteners that are the colloidal structures.

For another lamp strip provided in the present disclosure, the length of the wires is not limited, so that the length of the lamp strip can satisfy various scenes that need a long lamp strip. In addition, by reflow-soldered the patch lamp beads on the fixing plates, and soldering the wires to the second connection terminals of the fixing plates, a lamp string formed has stronger tension, and this connection method will not damage the patch lamp beads, or make the patch lamp beads to be affected by temperature, thus the lamp beads can be better protected. As the fixing plates are connected to the wires through the second connection terminals, the wiring of the fixing plates is convenient, and positions of providing the second connection terminals are not restricted. Moreover, circuits corresponding to the patch lamp beads can be directly arranged on the fixing plates, and types of the patch lamp beads are not restricted.

Further, the lamp strip in the present disclosure can be formed into a flat strip-like structure, wherein the structure is smooth without concave or convex parts. The fasteners that are colloidal structures can be provided to stick the lamp strip at a desired position, and the fixed lamp strip is also smoother and more beautiful. In addition, the connection line material also can be provided for the lamp strip, and the tension of the lamp strip can be further enhanced by the connection line material.

Based on the above embodiments, an embodiment of the present disclosure further provides a light-emitting device, wherein the light-emitting device is provided with the above lamp strip. In the above, the light-emitting device is further provided with a power supply connector, wherein this power supply connector is configured to connect a wire and a power supply, so as to transmit an electrical signal to the patch lamp bead.

The light-emitting device provided in the embodiment of the present disclosure has the same technical features as the light-emitting device provided in the above embodiments, and therefore also can solve the same technical problems and achieve the same technical effects.

In addition, in the description of the embodiments of the present disclosure, unless otherwise specified and defined explicitly, the terms “mount”, “join”, and “connect” should be construed in a broad sense, for example, a connection can be a fixed connection, a detachable connection, or an integral connection; it can be a mechanical connection, and also can be an electrical connection; it can be a direct connection, an indirect connection through an intermediary medium, or an inner communication between two elements. The specific meanings of the above terms in the present disclosure can be understood by those skilled in the art according to specific circumstances.

In the description of the present disclosure, it should be noted that orientation or positional relationships indicated by the terms such as “center”, “upper”, “lower”, “left”, “right”, “vertical”, “horizontal”, “inner”, and “outer” are based on orientation or positional relationships shown in the drawings, merely for facilitating the description of the present disclosure and simplifying the description, rather than indicating or implying that related devices or elements have to be in the specific orientation, or configured and operated in the specific orientation, therefore, they should not be construed as limitation to the present disclosure. Besides, the terms “first”, “second”, and “third” are for descriptive purpose only, but should not be construed as indicating or implying importance in the relativity.

Finally, it should be noted that the above embodiments are merely specific embodiments of the present disclosure, for illustrating the technical solutions of the present disclosure, rather than limiting the present disclosure, and the scope of protection of the present disclosure should not be limited thereto. While the detailed description is made to the present disclosure with reference to the preceding embodiments, those ordinarily skilled in the art should understand that within the technical scope disclosed in the present disclosure, anyone familiar with the present technical field still could make modifications or readily envisage changes to the technical solutions disclosed in the preceding embodiments, or make equivalent substitutions to some of the technical features therein. These modifications, changes, or substitutions do not make the essence of the corresponding technical solutions depart from the spirit and scope of the technical solutions of the embodiments of the present disclosure, and they all should be covered within the scope of protection of the present disclosure. Therefore, the scope of protection of the present disclosure should be based on the scope of protection of the claims.

The invention claimed is:

1. A lamp strip, comprising a lamp strip jacket, a plurality of illuminant components, and wires for connecting the plurality of illuminant components;
the wires and the plurality of illuminant components are arranged in the lamp strip jacket, and the lamp strip jacket is configured to form a protective structure for the wires and the plurality of illuminant components, wherein
the illuminant components each comprise a fixing plate and a patch lamp bead, wherein the fixing plate is configured to be connected to the wires, and bear the patch lamp bead; and
the wires are configured to transmit an electrical signal to the patch lamp bead through the fixing plate, so as to turn on the patch lamp bead.

2. The lamp strip according to claim 1, wherein the patch lamp bead comprises a plurality of pins; and the wires are provided corresponding to the pins;
a first plane of the fixing plate is provided with a plurality of first connection terminals, and a second plane of the fixing plate is provided with a plurality of second connection terminals; and
the patch lamp bead is fixedly connected to the first connection terminals through the pins, and the second connection terminals are configured to be connected with the wires.

3. The lamp strip according to claim 1, wherein the patch lamp bead is connected to the fixing plate by a reflow soldering.

4. The lamp strip according to claim 1, wherein the lamp strip jacket comprises a wire sheath and a lamp bead cover body, and the lamp bead cover body and the wire sheath are connected; and
the lamp bead cover body is provided outside a corresponding illuminant component; and the wire sheath is wrapped outside a corresponding wire.

5. The lamp strip according to claim 4, wherein the wire sheath is of a colloidal structure; the lamp bead cover body is a sealing layer, and sealing layers corresponding to the illuminant components are connected by the colloidal structure corresponding to the wire sheath.

6. The lamp strip according to claim 1, wherein the lamp strip further comprises a plurality of fasteners, and the fasteners are each configured to be fixed outside the lamp strip jacket;
the plurality of fasteners are provided at intervals along a length direction of the lamp strip jacket; and
the fasteners are configured to fix the lamp strip to an external structure.

7. The lamp strip according to claim 6, wherein the fasteners comprise colloidal structures, and are configured to stick and fix the lamp strip.

8. The lamp strip according to claim 2, wherein
the plurality of second connection terminals is distributed at two opposite sides of the fixing plate; and
the plurality of wires corresponding to the second connection terminals at each side are arranged side by side along a width direction of the fixing plate, so that the lamp strip is of a flat strip-like structure.

9. (canceled)

10. A light-emitting device, wherein the light-emitting device is provided with the lamp strip according to claim 1.
